(19) United States
(12) Patent Application Publication
(10) Pub. No.: US 2004/0062301 A1
(43) Pub. Date: Apr. 1, 2004

(54) Jitter measurement apparatus and jitter measurement method

(76) Inventors: Takahiro Yamaguchi, Tokyo (JP); Masahiro Ishida, Tokyo (JP); Mani Soma, Seattle, WA (US)

Correspondence Address: ROSENTHAL & OSHA L.L.P., Suite 2800, 1221 McKinney St., Houston, TX, 77010, US

(21) Appl. No.: 10/260,724

(22) Filed: Sep. 30, 2002

(51) Int. Cl. H04Q 1/20; H04B 3/46

(52) U.S. Cl. 375/226

(57) ABSTRACT

A jitter measurement apparatus for measuring a jitter of a signal under measurement includes: a delay circuit which generates a delayed signal that is delayed from the signal under measurement by a predetermined delay time; and a phase detector which detects an instantaneous phase error between the signal under measurement and the delayed signal.

### BACKGROUND OF THE INVENTION

1. Field of the Invention

The present invention relates to a jitter measurement apparatus and a jitter measurement method. More particularly, the present invention relates to a jitter measurement apparatus and a jitter measurement method that measure a jitter of a signal under measurement output from a circuit, electronic device and apparatus under test.

2. Description of the Related Art

Conventionally, as a method for measuring the jitter of the signal under measurement such as a clock signal or a data signal, the following technique has been disclosed, for example.

U.S. Pat. No. 6,295,315 (hereinafter, referred to as related art 1) discloses a technique for measuring a period of the signal under measurement by using two oscillator having different frequencies. According to this method, a histogram of frequency of the signal under measurement is calculated by repeating the period measurement, and a period jitter value is then estimated based on the histogram. In such a period jitter measurement method, dead time during which the period of the signal under measurement cannot be measured occurs between a certain period measurement and the next period measurement. Thus, this technique is classified into a time-interval analyzer having non-zero dead time.

S. Sunter and A. Roy, “BIST for Phase-Locked Loops in Digital Applications”, Proceedings of International Test Conference, pp. 532-540, September 1999 (hereinafter, referred to as related art 2) discloses a method in which a reference clock is provided with a delay time and is then input to a clock terminal of a positive edge trigger type D flip-flop and the D flip-flop takes in a logical value of a PLL clock output from the PLL under test in synchronization with risings of the delayed reference clock. This method compares the taken logical value with an expected value and counts a bit error rate. More specifically, a probability distribution function is measured by counting the bit error rate while the delay time is changed from the minimum delay time to the maximum delay time by means of a digitally-controlled variable delay circuit. In the above, the reference clock provides the PLL under test with a reference frequency. This method requires a high-precision control for the delay time of the digitally-controlled variable delay circuit. In addition, although the probability distribution function of the jitter is estimated, the jitter is not measured directly.

Tsuchida, “Generation of highly stabilized optical pulse of femtoseconds” ETL NEWS, July 1999 and H. Tsuchida, “Pulse Timing Stabilization of a Mode-Locked Cr:LiSAF Laser”, Optical Letters, Vol.24, No. 22, pp. 2641-1643, November 1999 (hereinafter, related art 3) discloses a method that suppresses timing fluctuation of the optical pulse so as to allow the stabilized optical pulses to be generated. This method directly detects the instantaneous phase in time domain by using a phase frequency detector shown in FIG. 17. Since the oscillation frequency of a mode-locked laser that requires a high-precision reference signal and the oscillation frequency of an over controlled crystal oscillator are not coincident with each other, a low-pass filter is required. A phase error signal output from the digital phase detector is subjected to Fourier transform, so that phase noise power spectra is obtained.

In the art of communication, it is essential to perform not only the period jitter measurement but also timing jitter measurement.

However, since the method of the related art 1 measures the period jitter by measuring the interval between zero-crossings, it cannot measure the timing jitter. Moreover, this method has a disadvantage that it takes a long time to obtain the necessary number of samples of data for jitter analysis because of the generated dead time.

The method of the related art 2 obtains the bit error rate but does not measure the timing jitter directly. Moreover, according to this method, it is necessary to change a range where the delay time is changed in accordance with the peak-to-peak value of the jitter included in the signal under measurement, and also in this case it is necessary to precisely change the delay time. However, the delay time is very sensitive to variation in a semiconductor fabrication process. Thus, it is difficult to precisely set the amount of the delay time. Therefore, according to the method of the related art 2, it is hard to measure the jitter of the clock, especially, high-frequency clock.

The method of the related art 3 requires a precise reference signal in order to detect the instantaneous phase of the signal under measurement. Thus, in a case where the jitter of the reference signal cannot be ignored with respect to the jitter of the signal under measurement, it is likely to overestimate the timing jitter value. Moreover, it is known that the phase frequency detector typically has non-linearity. In other words, the phase frequency detector has sharp frequency-discriminating characteristics and therefore can discriminate the magnitude of the frequency f_{VCO} of the signal under measurement and the frequency f₀ of the reference signal. The phase frequency detector supplies the output that is in proportion to the phase difference only when f_{VCO} and f₀ are equal to each other. On the other hand, since the signal under measurement and the reference signal are generated by different oscillators, there is typically a frequency difference. Therefore, when the instantaneous phase fluctuation of the signal under measurement is measured by means of the phase frequency detector, the frequency difference is also measured. The output characteristics are not symmetrical with respect to the frequency difference and therefore are not preferable. In order to make this frequency difference zero, it is necessary to make the frequency f₀ of the reference clock coincident with the oscillation frequency f_{VCO} of the PLL clock by using another PLL.

### SUMMARY OF THE INVENTION

Therefore, it is an object of the present invention to provide a jitter measurement apparatus and a jitter measurement method, which are capable of overcoming the above drawbacks accompanying the conventional art. The above and other objects can be achieved by combinations described in the independent claims. The dependent claims define further advantageous and exemplary combinations of the present invention.

According to the first aspect of the present invention, a jitter measurement apparatus for measuring a jitter of a signal under measurement, comprises: a delay circuit operable to generate a delayed signal that is delayed from the signal under measurement by a predetermined delay time; and a phase detector operable to detect an instantaneous phase error between the signal under measurement and the delayed signal.

The jitter measurement apparatus may further comprise an accumulator operable to accumulate the instantaneous phase error and to output a timing jitter sequence of the signal under measurement based on a value of accumulation.

The jitter measurement apparatus may further comprise a linear component remover operable to output non-linear components of the timing jitter-sequence by removing a linear component of the timing jitter sequence.

The linear component remover may output the non-linear components of the timing jitter sequence by removing a DC component of the timing jitter sequence.

The accumulator may include a converter operable to convert the instantaneous phase error to an electric signal and an integrator operable to integrate and accumulate the electric signal, and the jitter measurement apparatus may further comprise a discharge circuit operable to remove a linear component included in the instantaneous phase error, accumulated in the integrator to correspond to the delay time, from the integrator.

The jitter measurement apparatus may further comprise a jitter detector operable to detect the jitter of the signal under measurement based on the timing jitter sequence.

The jitter detector may include a peak-to-peak detector operable to calculate the jitter based on a difference between a maximum value and a minimum value of the timing jitter sequence.

The jitter detector may include a root mean square (RMS) detector operable to calculate the jitter based on a root mean square value of the timing jitter sequence.

The jitter detector may include a histogram estimator operable to calculate a histogram of the timing jitter sequence.

The jitter measurement apparatus may further comprise a period jitter estimator operable to calculate a period jitter of the signal measurement based on the instantaneous phase error.

The period jitter estimator may calculate the period jitter sequence by subtracting a mean value of the instantaneous phase error from the instantaneous phase error.

The delay circuit may generate the delayed signal by delaying the signal under measurement by N periods (where N is an integer equal to or larger than one); and the phase detector may calculate a period jitter sequence of the signal under measurement by detecting the instantaneous phase error between the signal under measurement and the delayed signal delayed from the signal under measurement by N periods.

The jitter measurement apparatus may further comprise a differentiator operable to calculate a differential sequence of the period jitter sequence and outputs the differential sequence as a cycle-to-cycle period jitter sequence of the signal under measurement.

The delay circuit may be a digitally-controlled variable delay circuit operable to hold the delay time in variable manner.

The jitter measurement apparatus may further comprise an accumulator operable to accumulate the period jitter sequence and output a timing jitter sequence of the signal under measurement based on the accumulated value.

The accumulator may include: a converter operable to convert the period jitter sequence into an electric signal; and an integrator operable to integrate and accumulate the electric signal.

According to the second aspect of the present invention, a jitter measurement method for measuring a jitter of a signal under measurement, comprises: generating a delayed signal that is delayed from the signal under measurement by a predetermined delay time; and detecting an instantaneous phase error between the signal under measurement and the delayed signal.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 shows a jitter measurement system 10 according an embodiment of the present invention.

FIG. 2A shows a structure of a phase frequency detector 1000 of the embodiment of the present invention.

FIG. 2B shows an operation of the phase frequency detector 1000 of the embodiment of the present invention.

FIG. 3 shows a jitter measurement flow by the jitter measurement system 10 of the embodiment of the present invention.

FIG. 4 shows a exemplary signal under measurement of the embodiment of the present invention.

FIG. 5 shows an exemplary waveform of a period jitter of the signal under measurement of the embodiment of the present invention.

FIG. 6A shows an exemplary waveform of a timing jitter measured by a conventional Δφ method.

FIG. 6B shows an exemplary waveform of the timing jitter measure by the jitter measurement flow shown in FIG. 3.

FIG. 7 shows an exemplary waveform of a cycle-to-cycle period jitter of the signal under measurement.

FIG. 8 shows a structure of a jitter measurement apparatus 200 of the embodiment of the present invention.

FIG. 9 shows a structure of the jitter measurement apparatus 200 according to the first modified example of the embodiment of the present invention.

FIG. 10 shows a structure of the jitter measurement apparatus 200 according to the second modified example of the embodiment of the present invention.

FIG. 11 shows a structure of a delay circuit 210, a phase detector 220 and an accumulator 230 of the jitter measurement apparatus 200 of the embodiment of the present invention.

FIG. 12A shows a structure of a converter 900 of the embodiment of the present invention.

FIG. 12B shows an operation of the converter 900 of the embodiment of the present invention.

FIG. 13A shows a structure of an integrator 910 of the embodiment of the present invention.

FIG. 13B shows an operation of the integrator 910 of the embodiment of the present invention.

FIG. 14 shows a structure of the phase detector 220 according to the third modified example of the embodiment of the present invention.

FIG. 15 shows a structure of the delay circuit 210, the phase detector 220, the accumulator 230 and a linear component remover 1450 of the jitter measurement apparatus 200 according to the fourth modified example of the embodiment of the present invention.

FIG. 16 shows an exemplary comparison result of timing jitter values measured by a conventional jitter measurement method and the jitter measurement method of the present invention.

FIG. 17 shows a structure of a conventional digital phase detector.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

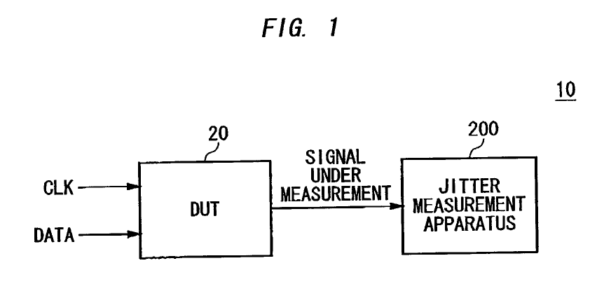

FIG. 1 shows a jitter measurement system 10 according to an embodiment of the present invention. The jitter measurement system 10 of the present embodiment includes a DUT 20 that is to be subjected to jitter measurement and a jitter measurement apparatus 200 that measures a jitter of the DUT 20.

The DUT 20 is a circuit, electronic device or system under test which operates based on a reference clock and input data that are input from the outside thereof. The jitter measurement apparatus 200 receives as an input a signal under measurement such as a data signal output from the DUT 20 or a PLL clock signal generated by a PLL provided in the DUT 20 based on the reference clock, and then measures a jitter of the signal under measurement.

Next, the jitter measured by the jitter measurement apparatus 200 in the present embodiment is defined.

A clock signal including no jitter is generally a square wave having a fundamental frequency f₀. This clock signal can be resolved into harmonics including f₀, 3f₀, 5f₀, . . . , by Fourier analysis. The jitter corresponds to fluctuation of the fundamental frequency of the signal under measurement. Thus, in jitter analysis, only signal components around the fundamental frequency are considered.

In a case where the clock signal having jitter is considered as the signal under measurement, the fundamental sinusoidal wave component is represented by Expression (1)

$$x ( t ) = A cos ( φ ( t ) ) = A cos ( \frac{2 π}{T} t + {φ}_{0} - Δφ ( t ) ) \qquad ( 1 )$$

where A and T represent an amplitude and a fundamental period.

(a) Definition of Timing Jitter

In the above, φ(t) is a instantaneous phase of the signal under measurement, and can be represented by the sum of a linear instantaneous phase component 2πt/T, an initial phase component φ0 and an instantaneous phase noise component Δφ(t).

When the instantaneous phase noise component Δφ(t) is zero, the signal under measurement includes no jitter and an interval between zero-crossings of the signal under measurement is the fundamental period T of the clock signal. On the other hand, when instantaneous phase noise component Δφ(t) is not zero, timings at which the signal under measurement crosses zero are varied in accordance with values of Δφ(t) at the zero-crossings of the signal under measurement. Such temporal variation at the zero-crossings is called as a timing jitter, which is defined as Δφ(nT) with respect to the zero-crossing point nT.

Δφ[n]=Δφ(nT) [rad] (2)

(b) Definition of Period Jitter

A period jitter generally corresponds to a difference of the timing jitter between the adjacent rising zero-crossing points, and is defined by the following expression.

$$J [ k ] = \frac{Δφ [ k + 1 ] - Δφ [ k ]}{\frac{2 π}{T}} [ sec ] \qquad ( 3 )$$

In Expression (3), unit of the period jitter is converted from rad to sec by multiplication using T/2π. Alternatively, rad may be used as unit of the period jitter.

(c) Definition of Cycle-to-cycle Period Jitter

A cycle-to-cycle period jitter J_{CC} indicates how much the instantaneous period of the clock signal varies. Thus, the cycle-to-cycle period jitter J_{CC}[n] is represented by a difference of the instantaneous period between the adjacent two clock cycles as indicated by Expression (4).

$$\begin{matrix}{J}_{CC} [ n ] = T [ n + 1 ] - T [ n ] \\ = ( T + J [ n + 1 ] ) - ( T + J [ n ] ) [ sec ] \\ = J [ n + 1 ] - J [ n ]\end{matrix} \qquad ( 4 )$$

As represented by Expression (4), the cycle-to-cycle period jitter J_{CC} [n] can be calculated as a difference series of a period jitter series.

Alternatively, the timing jitter, period jitter and cycle-to-cycle period jitter may be defined based on predetermined values or timings at which the signal under measurement crosses a predetermined phase other than the zero-crossing points, such as the maximum and minimum values of the signal under measurement.

The timing jitter mentioned above can be detected by using a phase frequency detector as discussed below.

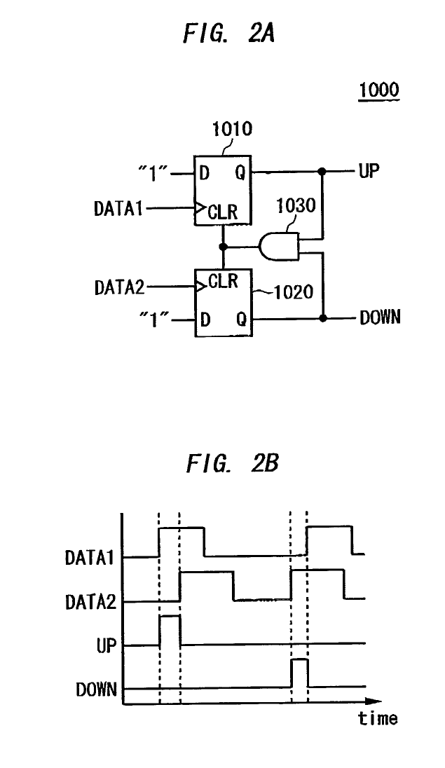

FIG. 2A shows an exemplary structure of a phase frequency detector 1000 of the present embodiment. The phase frequency detector 1000 of the present embodiment is an exemplary phase detector and includes a D flip-flop 1010, a D flip-flop 1020 and an AND gate 1030.

The D flip-flop 1010 stores D input “1” at a rising edge of input signal DATA1 and outputs it from a Q output. The D flip-flop 1020 stores D input “1” at a rising edge of input signal DATA2 and outputs it from a Q output. The AND gate 1030 clears the D flip-flops 1010 and 1020 in a case where both the Q outputs of the D flip-flops 1010 and 1020 are “1”, thereby making the D flip-flops 1010 and 1020 store “0”.

FIG. 2B shows an operation of a delay circuit 210 according to the present embodiment. In a case where input signal DATA 2 rises at a timing delayed from the rising edge of input signal DATA 1, a pulse signal having a width equal to a time difference between the rising of input signal DATA1 and the rising of input signal DATA2 is output to UP signal that is Q output of the D flip-flop 1010. On the other hand, in a case where input signal DATA1 rises at a timing delayed from the rising edge of input signal DATA2, a pulse signal having a width equal to a time difference from the rising of input signal DATA 2 to the rising of input signal DATA1 is output to a DOWN signal that is the Q output of the D flip-flop 1020. In this manner, the D flip-flip 1010 can outputs the time difference between the rising edges of the two input signals.

The phase frequency detector described above can be used for stabilizing an oscillation frequency in a Phase-Locked Loop, for example. More specifically, it is necessary to feed-back control an instantaneous phase φ(t) of an output waveform of an oscillator so as to stabilize an instantaneous frequency

$$\frac{ⅆ φ ( t )}{ⅆ t}$$

of the output waveform of the oscillator because a clock having a precise period cannot be generated even if a voltage controlled oscillator operates freely. Thus, as discussed below, an instantaneous phase of an input waveform can be obtained by using the phase frequency detector.

The phase frequency detector operates by detecting the zero-crossings of the input clock, i.e., the rising edges. When PLL clock x_{VCO}(t) and the reference clock X_{REF}(t) are assumed to be sinusoidal waves, they can be represented by Expression (5).

x_{REF}(t)=A_{REF} cos[2πf₀t+θ_{0]}

x_{VCO} (t)=A_{VCO}cos[2πf_{VOC}t−Δφ(t)+φ₀] (5)

In Expression (5), it is assumed that a phase noise of x_{REF}(t) is sufficiently small as compared with that of x_{VCO}(t) and therefore can be ignored. Moreover, when it is assumed that mean frequencies are coincident with each other, that is, f_{VCO}=f₀, the instantaneous phase (Expression (6)) at the zero-crossing (t=nT) of x_{REF}(t) and the instantaneous phase (Expression (7)) of the zero-crossing (t=nT) of x_{VCO}(t) are controlled to be coincident with each other by feed-back control using the phase frequency detector.

θ(nT)=2πf₀(nT)+θ₀ (6)

φ(nT)=2πf₀(nT)−Δφ(nT)+φ₀ (7)

An instantaneous phase error between x_{REF}(t) and x_{VCO}(t) at the zero-crossing (t=nT) is given by Expression (8).

ε(nT)≡Δφ(nT)+(θ₀−φ₀) (8)

Therefore, the timing jitter is obtained from the instantaneous phase error between x_{REF}(t) and x_{VCO}(t) output from the phase frequency detector. Please note that the second term on the right side of Expression (8), (θ₀−φ₀), becomes a constant and forms a DC component.

The UP signal output and the DOWN signal output of the phase frequency detector are input to, for example, a charge pump circuit, and is then converted into particular analog signal levels. Alternatively, the UP signal output and the DOWN signal output may be input to a differential amplifier where they are converted into DC signals by a low-pass filter. Please note that the phase frequency detector 1000 shown in FIG. 2A can detect a phase difference from a phase delay of one period and a phase advance of one period. Thus, when the phase difference of the inputs is in a region of (−2π, 2π), the output of the phase frequency detector 1000 becomes linear.

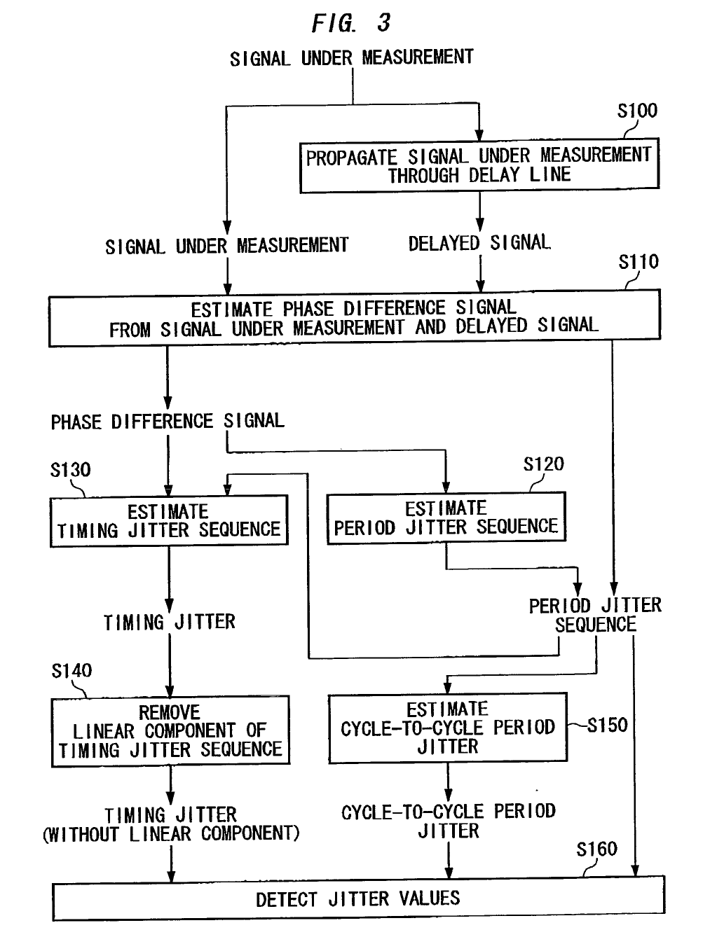

FIG. 3 shows a jitter measurement flow by the jitter measurement system 10 according to the present embodiment. The jitter measurement flow by the jitter measurement system 10 is described below, referring to a case where the signal under measurement is a PLL clock of x_{VCO}(t) as an example.

In Delay step S100, a delayed signal obtained by delaying the signal under measurement by a predetermined delay time is generated. Then, in Phase detection step S110, the instantaneous phase error between the signal under measurement and the delayed signal is detected by using a phase detector such as a phase frequency detector, and is output as a phase difference signal. In this manner, when two signals obtained from the same PLL clock are input to the phase frequency detector, the frequencies of these two signals are the same and therefore frequency offset between the two signals can be made zero. Thus, since an offset of period between the two signals cannot be accumulated, the phase difference between the two signals can be suppressed within a range of (−2π, 2π), allowing the phase frequency detector to operate in a linear region.

The jitter measurement system operates in two ways described below, in accordance with the delay time in Delay step S100.

(a) Case Where the Delay Time is Set to Unit Time Delay T that Corresponds to the Fundamental Period of the Signal Under Measurement

When the delayed signal obtained by providing the unit time delay T with the signal under measurement x_{VCO}(t) and the signal under measurement are input to the phase frequency detector, Expression (9) can be obtained because it is unnecessary to consider DC components in Expression (7).

ε[n]≡ε(nT)=Δφ((n+1)T)−Δφ(nT)≡Aφ[n+1]−Δφ[n] (9)

Thus, in case (a), a period jitter sequence can be detected by Phase detection step S110.

Next, in Timing jitter detection step S130, the instantaneous phase errors that form the period jitter sequence, that were detected in Phase detection step S110, are accumulated and a timing jitter sequence of the signal under measurement is output based on the accumulated value. In other words, since the sequence of the instantaneous phase errors in Expression (9) is represented by Expression (10), the timing jitter sequence can be obtained as represented by Expression (11) by accumulating the output of the phase frequency detector.

$$\begin{matrix}\begin{matrix}ϵ [ n - 1 ] = Δφ [ n ] - Δφ [ n - 1 ] \\ ϵ [ n - 2 ] = Δφ [ n - 1 ] - Δφ [ n - 2 ] \\ ϵ [ n - 3 ] = Δφ [ n - 2 ] - Δφ [ n - 3 ] \\ Λ \\ Λ \\ ϵ [ 1 ] = Δφ [ 2 ] - Δφ [ 1 ]\end{matrix} & ( 10 ) \\ Δφ [ n + 1 ] - Δφ [ 1 ] = {\sum }_{k = 1}^{n} ϵ [ k ] & ( 11 )\end{matrix}$$

Please note that the second term on the left side of Expression (11), Δφ[1], is a constant value that is not dependent on n and therefore becomes a DC component in the timing jitter sequence.

Then, by removing the DC components that are linear components in the timing jitter sequence in Linear component removal step S140, non-linear components of the timing jitter sequence are output.

The jitter measurement method in case (a) can obtain an instantaneous phase error sequence ε[n]≡Δφ[n+1]−Δφ[n] at the zero-crossings between the signal under measurement x(t) and the delayed signal x(t-T) obtained by providing the unit time delay with the signal under measurement, i.e., a period jitter sequence J[n], by inputting these two signals to the phase frequency detector in Phase detection step S110.

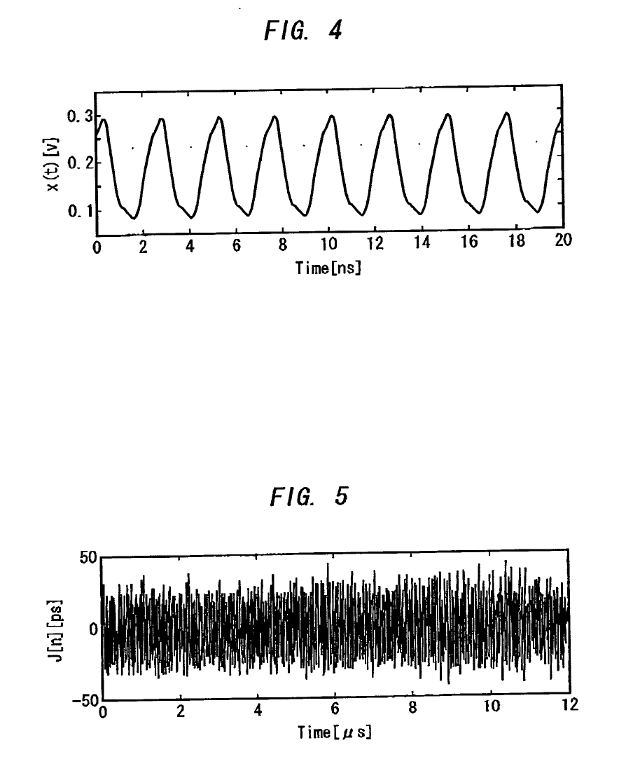

FIG. 4 shows an example of the signal under measurement. In addition, FIG. 5 shows a period jitter sequence J[n] obtained from the signal under measurement shown in FIG. 4 by using this jitter measurement method.

Next, in Jitter detection step S160, jitter values of the signal under measurement may be based on the period jitter sequence J[n].

More specifically, in Jitter detection step S160, an RMS value and a peak-to-peak value of the period jitter are calculated as the jitter of the signal under measurement. RMS period jitter J_{RMS} is a root mean square value that can be calculated by using Expression (12).

$${J}_{RMS} = \sqrt{\frac{1}{M} {\sum }_{k = 1}^{M} {J}^{2} [ k ]} [ sec ] \qquad ( 12 )$$

In the above, M represents the number of components of the period jitter sequence that were measured, and is the number of samples of period jitter data. Also, the peak-to-peak period jitter JPP is calculated by Expression (13), based on the difference between the maximum value and the minimum value of the period jitter sequence J[n].

$${J}_{PP} = {max}_{k} ( J [ k ] ) - {min}_{k} ( J [ k ] ) [ sec ] \qquad ( 13 )$$

Moreover, a histogram of the period jitter sequence may be calculated in Jitter detection step S160.

More specifically, as the jitter of the signal under measurement, the RMS value Δφ_{RMS} and the peak-to-peak value Δφₚₚ of the timing jitter are calculated by Expressions (14) and (15), based on the root mean square value or the difference between the maximum value and the minimum value of the timing jitter sequence.

$$\begin{matrix}{Δφ}_{RMS} = \sqrt{\frac{1}{N} {\sum }_{k = 1}^{N} {Δφ}^{2} [ k ]} [ rad ] & ( 14 ) \\ {Δφ}_{PP} = {max}_{k} ( Δφ [ k ] ) - {min}_{k} ( Δφ [ k ] ) [ rad ] & ( 15 )\end{matrix}$$

In the above, N is the number of the components of the timing jitter sequence, that were measured, and is the number of samples of timing jitter data.

Moreover, a histogram of the timing jitter sequence may be calculated in Jitter detection step S160.

The jitter measurement method in case (a) calculates the timing jitter sequence Δφ[n] by adding one after another the period jitter sequence J[n] obtained in Phase detection step S110, in Timing jitter detection step S130.

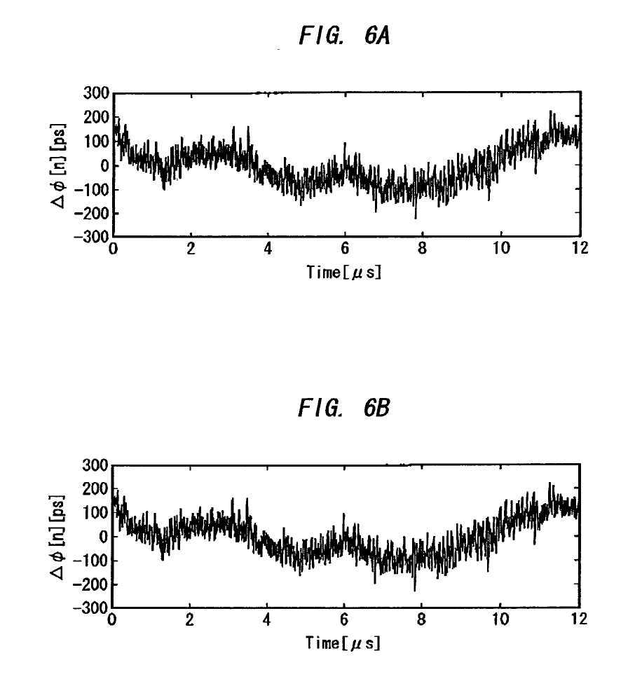

FIG. 6A shows a timing jitter waveform measured by a conventional Δφ method. On the other hand, FIG. 6B shows a timing jitter waveform Δφ[n] obtained from the signal under measurement shown in FIG. 4 by this jitter measurement method. As show in FIGS. 6A and 6B, the timing jitter waveform that is compatible with that obtained by the conventional measurement method can be obtained by the jitter measurement method of the present embodiment.

Moreover, the jitter measurement method of the present embodiment may output a cycle-to-cycle period jitter by calculating the differential sequence of the period jitter sequence in Cycle-to-cycle period jitter calculation step S150. The cycle-to-cycle period jitter J_{CC} is period fluctuation between the successive cycles and is represented by Expression (4).

Then, by calculating the root mean square value and the difference between the maximum value and the minimum value of the cycle-to-cycle period jitter obtained in Cycle-to-cycle period jitter calculation step S150, an RMS value J_{CC,RMS} and a peak-to-peak value J_{CC,PP} of the cycle-to-cycle period jitter can be calculated as represented by Expressions (16) and (17).

$$\begin{matrix}{J}_{CC , RMS} = \sqrt{\frac{1}{L} {\sum }_{k = 1}^{L} {J}_{CC}^{2} [ k ]} [ sec ] & ( 16 ) \\ {J}_{CC , PP} = {max}_{k} ( {J}_{CC} [ k ] ) - {min}_{k} ( {J}_{CC} [ k ] ) [ sec ] & ( 17 )\end{matrix}$$

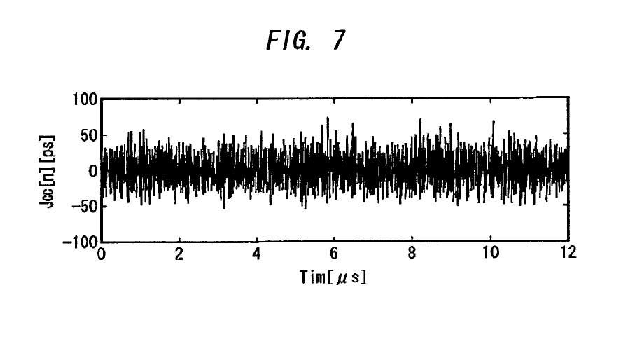

In the above, L is the number of the components of the cycle-to-cycle period jitter sequence that were measured, and is the number of samples of cycle-to-cycle period jitter data. A waveform of the cycle-to-cycle period jitter J_{CC}[n] that corresponds to the signal under measurement shown in FIG. 4, that was calculated by the jitter measurement method of the present embodiment is shown in FIG. 7.

(b) Case Where the Delay Time is Set to a Value Different From the Unit Time Delay T that is the Fundamental Period of the Signal Under Measurement

When the signal under measurement and the delayed signal obtained by providing Nᵣ unit time delay with the signal under measurement x_{VCO}(t) are input to the phase frequency detector, the instantaneous phase error represented by Expression (18) is obtained in the similar manner to Expression (9).

$$\begin{matrix}ϵ [ n , {N}_{τ} ] ≡ Δφ [ n + 1 ] - Δφ [ n - {N}_{τ} + 1 ] \\ = ( Δφ [ n + 1 ] - Δφ [ n ] ) + ( Δφ [ n ] - Δφ [ n - 1 ] ) + \\ Λ + ( Δφ [ n - {N}_{τ} - 2 ) ] - Δφ [ n - ( {N}_{τ} - 1 ) ] ) \\ \approx {N}_{τ} ( Δφ [ n + 1 ] - Δφ [ n ] )\end{matrix} \qquad ( 18 )$$

From Expression (18), the instantaneous phase error in the case where the delay time is set to the unit time delay T and that in the case where the delay time is set to Nᵣ unit time delay T have a relationship represented by Expression (19).

$$ϵ [ n ] \approx \frac{1}{{N}_{τ}} ϵ [ n , {N}_{τ} ] \qquad ( 19 )$$

The jitter measurement system 10 accumulates the instantaneous phase error detected by Phase detection step Slo in Timing jitter detection step S130, and outputs the timing jitter sequence of the signal under measurement based on the accumulated value. In other words, the jitter measurement system 10 can estimate the timing jitter sequence from Expressions (11) and (19) by using calculation and approximation represented by Expression (20).

$$Δφ [ n + 1 ] - Δ φ [ 1 ] = {\sum }_{k = 1}^{n} ϵ [ k ] \approx \frac{1}{N} {\sum }_{k = 1}^{n} ϵ [ k , {N}_{τ} ] \qquad ( 20 )$$

As described above, the timing jitter sequence can be obtained by inputting the signal under measurement and the delayed signal obtained by providing the signal under measurement x_{VCO}(t) with Nᵣ unit time delay to the phase frequency detector, accumulating the output of the phase frequency detector and dividing the accumulated value by Nᵣ. Here, Δφ[1] is a DC component in the timing jitter sequence as in Expression (11).

Next, in Linear component removal step S140, non-linear components are output by removing the DC component that is a linear component of the timing jitter sequence. Linear component removal step S140 removes the DC component in the timing jitter sequence, that is cause to occur by the following reason.

In a case where the delay time D in Delay step S100 in such a manner that D∫T, the output signal output from the phase frequency detector in Phase detection step S110 becomes a pulse signal having a width represented by Expression (21).

ε[n]=Δφ[n+1]−Δφ[n]+(T−D) (21)

Therefore, by obtaining the pulse width of the output pulse signal in Phase detection step S110 one after another and accumulating the obtained pulse width, Expression (22) is obtained as follows.

$${\sum }_{k = 1}^{n} ϵ [ k ] = Δ φ [ n + 1 ] - Δ φ [ n ] + ( T - D ) \qquad ( 22 )$$

The third term on the right side of Expression (22) is a linear component caused to occur by the fact that the delay time in Delay step S100 is different from the fundamental period T. Thus, in order to add the output the output of Phase detection step S110 so as to obtain the timing jitter sequence, it is necessary to remove the linear component n(T-D) from the signal obtained in Timing jitter detection step S130.

Next, the cycle-to-cycle period jitter may be calculated and output in Cycle-to-cycle period jitter calculation step S150 in the similar manner to that in case (a).

Then, in Jitter detection step S160, an RMS value, a peak-to-peak value and a histogram may be calculated so as to calculate jitter, for the period jitter sequence obtained in Phase detection step S110, the timing jitter sequence obtained in Timing jitter detection step S130 and/or Linear component removal step S140 or the cycle-to-cycle period jitter sequence obtained in Cycle-to-cycle period jitter calculation step S150.

In cases (a) and (b), Period jitter estimation step S120 may be performed in which the period jitter sequence of the signal under measurement is calculated based on the instantaneous phase error detected by Phase detection step S110. In Period jitter estimation step S120, an estimated value of the period jitter may be calculated by, for example, dividing the instantaneous phase error by Nᵣ based on Expression (19). Alternatively, the estimated value of the period jitter may be calculated by removing offset of the phase between the signal under measurement and the delayed signal.

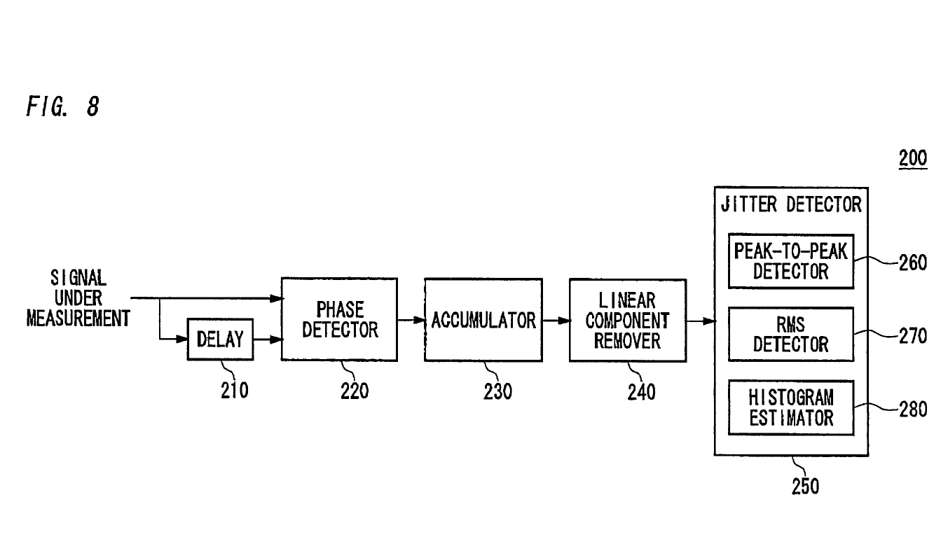

FIG. 8 shows an exemplary structure of jitter measurement apparatus 200 of the present embodiment. The jitter measurement apparatus 200 of the present embodiment includes a delay circuit 210, a phase detector 220 an accumulator 230, a linear component remover 240 and a jitter detector 250.

The delay circuit 210 generates a delayed signal obtained by delaying a signal under measurement that was input via an input terminal for signal under measurement of the jitter measurement apparatus 200 by a predetermined delay time, for example. That is, the delay circuit 210 performs the operation of Delay step S100 shown in FIG. 3. The delay circuit 210 may have a structure including a plurality of delay devices connected in cascade. Moreover, it is desirable that the delay circuit 210 be a digitally-controlled variable delay circuit in which the delay time can be adjusted by, for example, a control input from the outside and the adjusted delay time can be held in a variable manner, in order to set the delay time so as to be suitable for the frequency of the signal under measurement. In this case, the delay circuit 210 may have the structure in which a plurality of delay devices are connected in cascade, so as to realize a digitally-controlled variable delay circuit by selectively connecting one or more of these delay devices to a line through which the signal under measurement passes, for example.

The phase detector 20 receives as inputs the signal under measurement input via the input terminal for signal under measurement, for example, and the delayed signal generated by the delay circuit 210 and detects an instantaneous phase error between the signal under measurement and the delayed signal. That is, the phase detector 220 performs the operation of Phase detection step S110 shown in FIG. 3. In a case where the phase detector 220 is a phase detector that that detects the time difference from the rising of the signal under measurement to the rising of the delayed signal, it is desirable to set the delay time of the delay circuit 210 in such a manner that the delayed signal rises before the signal under measurement rises because of the time fluctuation of the signal under measurement. In another case where the phase detector 220 is a phase frequency detector that detects the time difference between the rising of the signal under measurement and the rising of the delayed signal and also detects which one of the signal under measurement and the delayed signal rises before the rising of the other, the delay time of the delay circuit 210 may be set to the fundamental period of the signal under measurement or a multiple of the fundamental period. Please note that the phase detector 220 may be a phase frequency detector such as the phase frequency detector 1000 shown in FIG. 2A.

The accumulator 230 accumulates the instantaneous phase error detected by the phase detector 220, and outputs the timing jitter sequence of the signal under measurement based on the accumulated value. That is, the accumulator 230 performs the operation of Timing jitter detection step S130 shown in FIG. 3.

The linear component remover 240 outputs non-linear components of the timing jitter sequence by removing the linear component of the timing jitter sequence output from the accumulator 230. That is, the linear component remover 240 performs the operation of Linear component removal step S140 shown in FIG. 3.

When the delay time of the delay circuit 210 is assumed to be a multiple of the fundamental period T of the signal under measurement in a case where the phase detector 220 is a phase frequency detector, the timing jitter sequence output from the accumulator 230 includes the DC component-Δφ[1] on the left side of Expression(11) or (22). In this case, the non-linear components of the timing jitter sequence are output by removing the DC component-Δφ[1] of the timing jitter sequence output by the accumulator 230 as a voltage signal.

In a case where the phase detector 220 is a phase detection circuit using an exclusive OR gate, when the delay time of the delay circuit 210 is 0.75T, the pulse width of the output signal of the phase detector 220 fluctuates because of the period jitter while a mean value of the pulse widths is ¼ of the fundamental period T of the signal under measurement. Therefore, when the pulse width of the output signal of the phase detector 220 is obtained one after another and is added up, the result of the addition includes the linear component of 0.25T. Thus, by adding up the output of the phase detector 220 by means of the accumulator 230 and removing the linear component by means of the linear component remover 240, the timing jitter sequence can be obtained. In this case, the delay time of the delay circuit 210 may be set to (m±0.5)T (m is an integer that is not zero).

The jitter detector 250 detects jitter of the signal under measurement based on the timing jitter sequence output from the linear component remover 240. That is, the jitter detector 250 performs the operation of Jitter detection step S160 shown in FIG. 3. The jitter detector 250 includes a peak-to-peak detector 260, an RMS detector 270, and a histogram estimator 280. The peak-to-peak detector 260 calculates the peak-to-peak value of the timing jitter sequence based on the difference between the maximum value and the minimum value of the timing jitter sequence output from the linear component remover 240, thereby calculating the jitter of the signal under measurement. The RMS detector 270 calculates the RMS value of the timing jitter sequence output from the linear component remover 240 based on the root mean square value, thereby calculating the jitter of the signal under measurement. The histogram estimator 280 calculates the histogram of the timing jitter sequence output from the linear component remover 240, thereby calculating the jitter of the timing jitter sequence.

In the above description, the jitter measurement apparatus 200 may output the output of the phase detector 220, the output of the accumulator 230 and the output of the linear component remover 240 as the period jitter sequence, the timing jitter sequence and the non-linear components of the timing jitter sequence, respectively.

Moreover, in a case where the delay time of the delay circuit 210 is set to unit time delay T, the phase detector 220 outputs the pulse signal having the pulse width corresponding to the period jitter as represented in Expression (9). Thus, the period jitter sequence of the signal under measurement can be obtained by calculating the pulse width of the phase detector 220 sequentially. Please note that the delay time of the delay circuit 210 my be set to a natural number times of the unit time delay T, the natural number being equal to or larger than two. In this case, the jitter detector 250 may receive as an input the period jitter sequence obtained from the phase detector 220 and calculate the peak-to-peak value, the RMS value or the histogram of the period jitter sequence.

As described above, the jitter measurement apparatus 200 according to the present embodiment can measure the jitter of the signal under measurement that was input via the input terminal for signal under measurement, for example, from the signal under measurement. Thus, it is unnecessary to apply the reference clock having the same frequency as that of the signal under measurement from the outside, and it is therefore possible to measure the jitter of the signal under measurement without using various measurement apparatuses required for generating the precise reference clock. Moreover, since the reference clock is not used, it is possible to suppress the effects of the frequency offset of the reference clock and the jitter component on the signal under measurement, enabling the jitter of the signal under measurement to be measured more precisely.

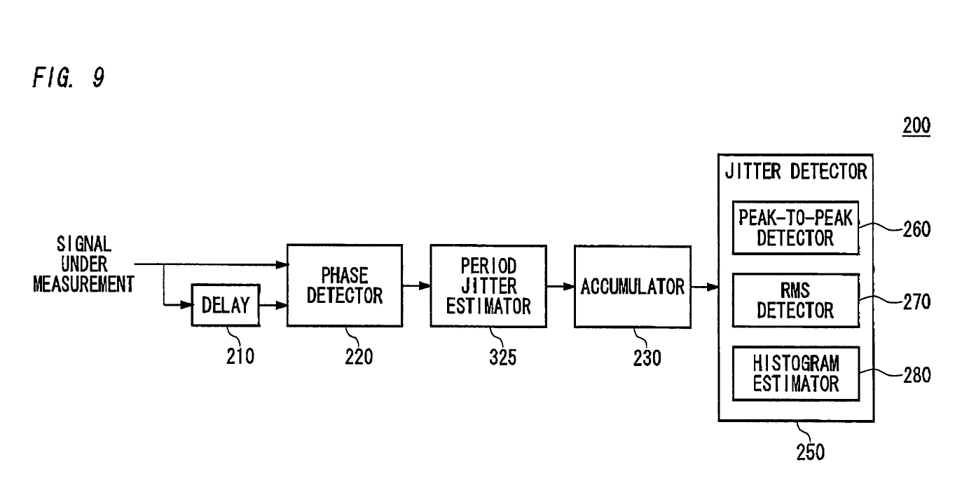

FIG. 9 shows a structure of the jitter measurement apparatus 200 according to the first modified example of the present embodiment. The jitter measurement apparatus 200 of the first modified example is different from the jitter measurement apparatus shown in FIG. 8 in that a period jitter estimator 325 is provided between the phase detector 220 and the accumulator 230 and the linear component remover 240 is not included. Therefore, the following description refers to the above differences mainly.

The period jitter estimator 325 calculates the period jitter sequence of the signal under measurement based on the instantaneous phase error detected by the phase detector 220. That is, the period jitter estimator 325 performs the operation of Period jitter estimation step S120 shown in FIG. 3. Please note that the delay circuit 210 in the first modified example outputs the delayed signal obtained by delaying the signal under measurement by (m±α) T (m is an integer that is not equal to zero, 0<α<1). In this case, the instantaneous phase error output from the phase detector 220 fluctuates around the fundamental frequency T of the signal under measurement with a value of ±αT considered as a mean value. Thus, in the period jitter estimator 325, the estimated value of the period jitter can be calculated by sequentially obtaining the width of the output signal of the phase detector 220, subtracting the mean value of the obtained pulse widths from the instantaneous phase error and dividing the result of the subtraction by Nᵣ (see Expression (18)).

In a case where the phase detector 220 is a phase detection circuit using an exclusive OR gate, for example, when the delay time of the delay circuit 210 is set to 0.75T, the pulse width of the output signal of the phase detector 220 fluctuates because of the period jitter with ¼ of the fundamental frequency of the signal under measurement considered as the mean value. Thus, in the period jitter estimator 325, the period jitter sequence of the signal under measurement can be obtained by sequentially obtaining the pulse width of the output signal of the phase detector 220 and subtracting 0.25T, that is the mean value of the pulse widths, from the instantaneous phase error. In this case, the delay time of the delay circuit 210 can be set to (m±0.25)T (m is an integer that is not zero).

In a case where the phase detector 220 is a phase detection circuit using a J-K flip-flop, when the delay time of the delay circuit 210 is set to 0.5T, the pulse width of the output signal of the phase detector 220 fluctuates because of the period jitter with ½ of the fundamental frequency of the signal under measurement considered as the mean value. Thus, in the period jitter estimator 325, the period jitter sequence of the signal under measurement can be obtained by sequentially obtaining the pulse width of the output signal of the phase detector 220 and subtracting 0.5T, that is the mean value of the pulse widths, from the instantaneous phase error. In this case, the delay time of the delay circuit 210 can be set to (m±0.5)T (m is an integer that is not zero).

In the above description, the jitter measurement apparatus 200 may output the output of the period jitter estimator 325 as the period jitter sequence and may output the output of the accumulator 230 as the timing jitter sequence or the non-linear components of the timing jitter sequence.

Moreover, the jitter detector 250 may receive as its input the period jitter sequence obtained from the period jitter estimator 325 and calculate the peak-to-peak value, the RMS value or the histogram of the period jitter sequence.

In addition, the jitter measurement apparatus 200 of this modified example may further include the linear component remover 240 shown in FIG. 8 between the accumulator 230 and the jitter detector 250.

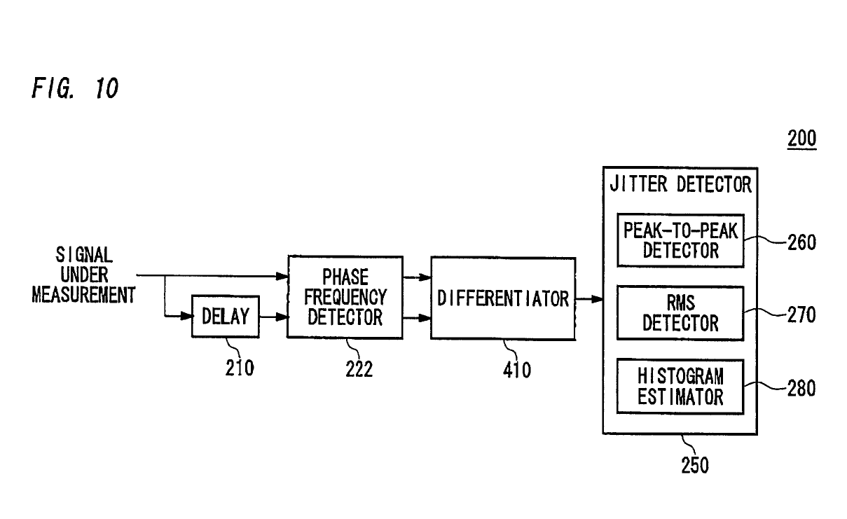

FIG. 10 shows a structure of the jitter measurement apparatus 200 according to the second modified example of the present embodiment. The jitter measurement apparatus 200 of the second modified example is different from that shown in FIG. 8 in that the phase detector 220 is placed with a phase frequency detector 222 and the accumulator 230 and linear component remover 240 are placed with a differentiator 410. Thus, the following description mainly refers to the above differences.

The phase frequency detector 222 detects the instantaneous phase error between the signal under measurement and the delayed signal. That is, the phase frequency detector 222 performs the operation of Phase detection step S110 shown in FIG. 3. The delay circuit 210 in the second modified example generates the delayed signal corresponding to a signal having a phase delayed from the signal under measurement by one period, by delaying the signal under measurement by the reference period T. The phase frequency detector 222 then calculates the instantaneous phase difference between the signal under measurement and the delayed signal delayed from the signal under measurement by one period, thereby calculating the period jitter sequence of the signal under measurement.

The differentiator 410 calculates the differential sequence of the period jitter sequence output from the phase frequency detector 222, and outputs it as a cycle-to-cycle period jitter sequence of the signal under measurement. That is, the differentiator 410 performs the operation of Cycle-to-cycle period jitter calculation step S150 shown in FIG. 3. The differentiator 410 may be realized by using a high-pass filter, for example.

The jitter detector 250 detects the jitter of the signal under measurement based on the cycle-to-cycle period jitter sequence output from the differentiator 410. That is, the jitter detector 250 performs the operation of Jitter detection step S160 shown in FIG. 3.

In the above description, the jitter measurement apparatus 200 may output the output of the phase frequency detector 222 and the output of the differentiator 410 as the period jitter sequence and the cycle-to-cycle period jitter, respectively.

In addition, the jitter detector 250 may receive as its input the period jitter sequence obtained from the period jitter estimator 325 and calculate the peak-to-peak value, the RMS value and the histogram of the frequency jitter sequence.

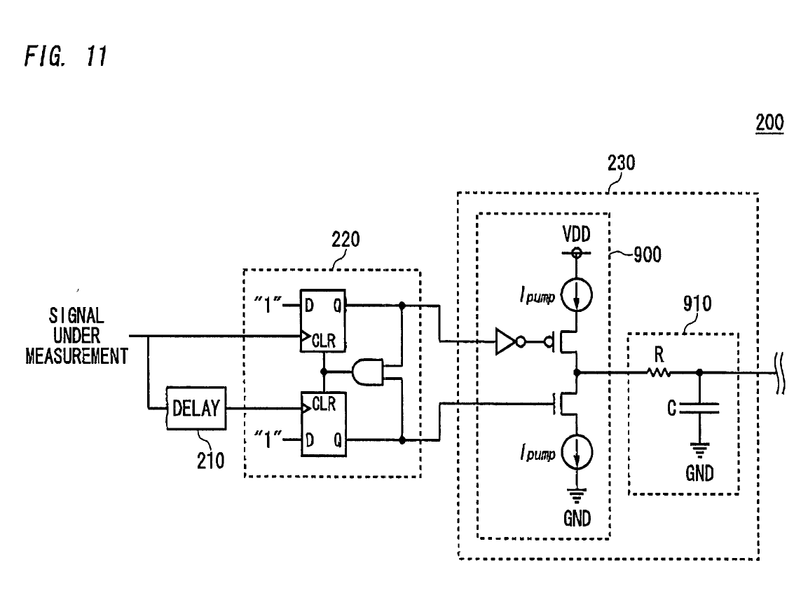

FIG. 11 shows an exemplary structure of the delay circuit 210, the phase detector 220 and the accumulator 230 in the jitter measurement apparatus 200 according to the present embodiment. The delay circuit 210 and the phase detector 220 are identical to the delay circuit 210 shown in FIG. 8 and the phase detector 220 shown in FIG. 2A, respectively, and therefore the description thereof is omitted.

The accumulator 230 of the present embodiment includes a converter 900 and an integrator 910.

The converter 900 is a charge-pump that converts the instantaneous phase error or the period jitter sequence detected by the phase detector 220 into an electric signal. The integrator 910 integrates the instantaneous phase error or period jitter sequence that was converted to the electric signal by the converter 900 and accumulate sit. In this way, the integrator 910 accumulates the instantaneous phase error or period jitter sequence detected by the phase detector 220 and outputs a voltage signal corresponding to the timing jitter sequence.

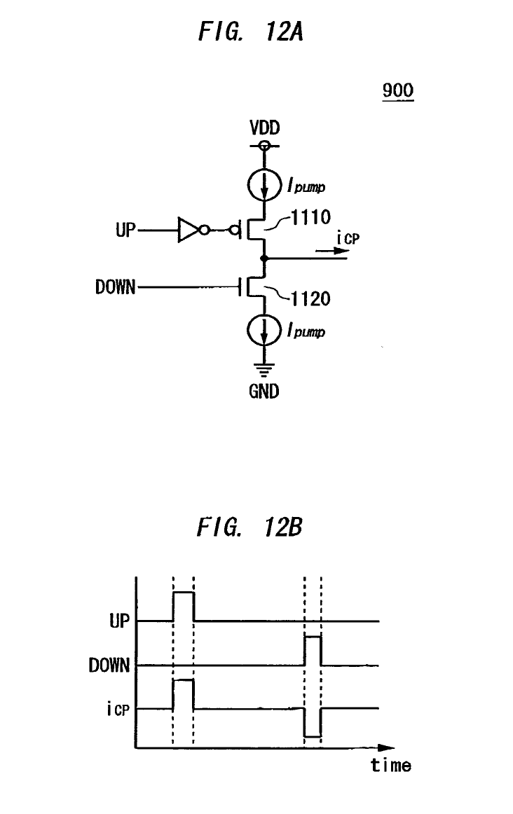

FIGS. 12A and 12B show the structure and the operation of the converter 900 of the present embodiment. The converter 900 turns a switch on when “1” is input to an UP signal, and charges the integrator 910 by supplying an electric current Iₚᵤₘₚ from a power supply VDD to the integrator 910 during a period in which “1” is supplied to the UP signal. Also, the converter 900 turns another switch on when “1” is input to a DOWN signal, and causes discharge of the integrator 910 to GND during a period in which “1” is supplied to the DOWN signal. In other words, the converter 900 converts the UP signal and DOWN signal having the pulse widths in proportion to the instantaneous phase error or period jitter sequence to an electric signal causing a positive or negative electric current Iₚᵤₘₚ that is in proportion to the pulse widths of the UP signal and the DOWN signal to flow, and outputs the electric signal to the integrator 910. In this way, the converter 900 outputs electric charges having the amount in proportion to the instantaneous phase error or period jitter sequence.

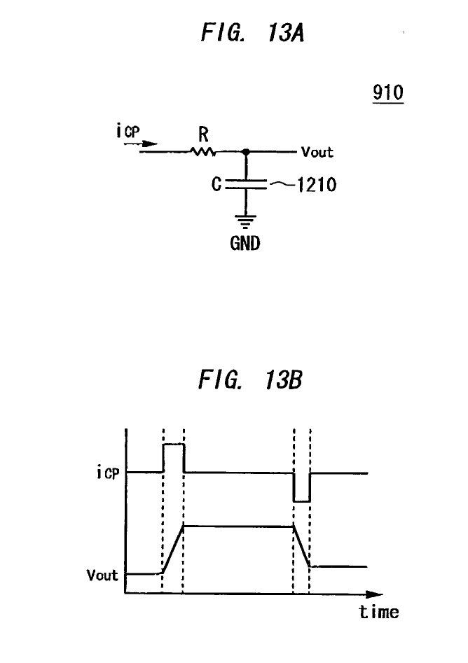

FIGS. 13A and 13B show a structure and an operation of the integrator 910 according to the present embodiment. The integrator 910 integrates the electric signal output from the converter 900 so as to charge a capacitor 1210. In this way, the integrator 910 accumulates the instantaneous phase error or period jitter sequence and outputs a voltage signal corresponding to the timing jitter sequence. The voltage signal output from the integrator 910 in a case where the period jitter sequence is accumulated is represented by Expression (23). From Expression (23), the capacitor 1210 of the integrator 910 outputs the voltage signal that is in proportion to the sum of the period jitter sequence.

$${v}_{out} = \frac{1}{C} \int {i}_{CP} ⅆ t = \frac{1}{C} {\sum }_{k} J [ k ] {I}_{pump} \qquad ( 23 )$$

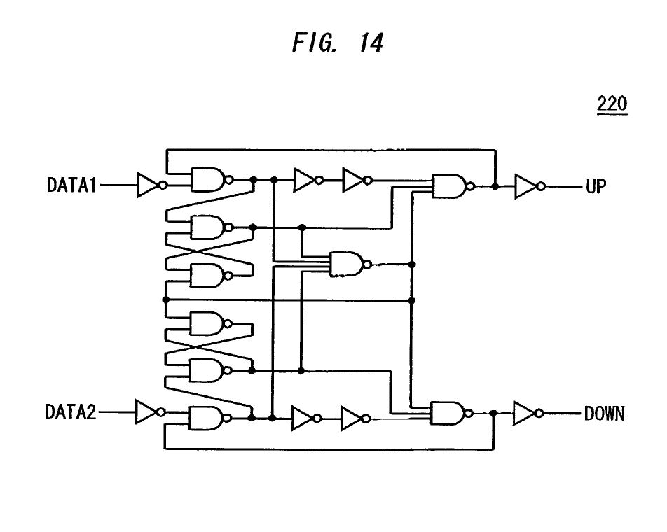

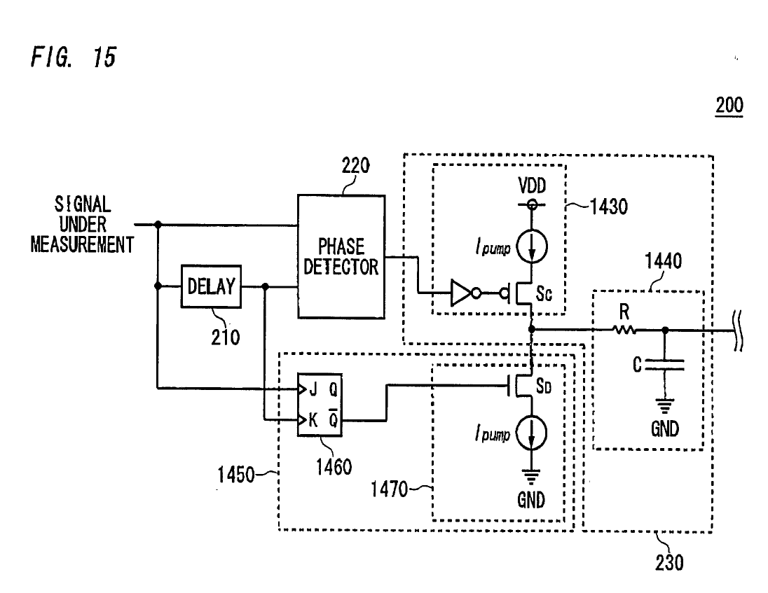

FIG. 14 shows a structure of the phase detector 220 according to the third modified example of the present embodiment. In a case of using a phase frequency detector as the phase detector 220, the phase detector 220 may be any one of the phase detector 220 shown in FIG. 2A, the phase detector 220 shown in FIG. 14 and a phase frequency detection circuit having other circuit structure.

FIG. 15 shows an exemplary structure of the jitter measurement apparatus 200 according to the fourth modified example of the present embodiment. The jitter measurement apparatus 200 of this modified example includes a linear component remover 1450 in addition to the components of the jitter measurement apparatus 200 shown in FIG. 8, but does not include the linear component remover 240. The delay circuit 210 and the phase detector 220 in this modified example are the same as the delay circuit 210 and the phase detector 220 shown in FIG. 8 and therefore the description is omitted except for the description of the differences.

The delay circuit 210 of this modified example generates a delayed signal that is delayed from the signal under measurement by a delay time D (0<D<T). The phase detector 220 of this modified example outputs a signal having a pulse width that is in proportion to the time difference from the rising of the signal under measurement to the rising of the delayed signal, thereby detecting the instantaneous phase error between the signal under measurement and the delayed signal.

The accumulator 230 includes a converter 143 that converts the instantaneous phase error to an electric signal and an integrator 1440 that integrates the electric signal and accumulates it. The converter 1430 receives as its input the pulse signal of the instantaneous phase error detected by the phase detector 220 and supplies an electric current Iₚᵤₘₚ to the integrator 1440 during a time period that is in proportion to the pulse width, thereby converting the instantaneous phase error to the electric signal. The integrator 1440 has the similar structure to that of the integrator 910 shown in FIG. 13A and therefore the description thereof is omitted.

The linear component remover 1450 removes the linear components included in the instantaneous phase error, accumulated in the integrator 1440 so as to correspond to the delay time of the delay circuit 210, from the integrator 1440. The linear component remover 1450 includes a JK flip-flop 1460 and a discharge circuit 1470.

The JK flip-flop 1460 causes the electric current Iₚᵤₘₚ to flow from the integrator 1440 to GND during a period in which the JK flip-flop 1460 outputs the pulse signal. In this way, the discharge circuit 1470 discharges the electric current Iₚᵤₘₚ from the integrator 1440 to GND during a period corresponding to the pulse width (T-D) of the pulse signal output from the JK flip-flop 1460.

As described above, the jitter measurement apparatus 200 according to this modified example accumulates the instantaneous phase error by means of the accumulator 230 and also subtracts a time (T-D) per period of the signal under measurement from the accumulator 230. In this way, the jitter measurement apparatus 200 of this modified example can removes the linear component at the third terms of Expressions (21) and (22). Thus, the accumulator 230 can output the non-linear components of the timing jitter sequence of the signal under measurement so as to supply them to the jitter detector 250.

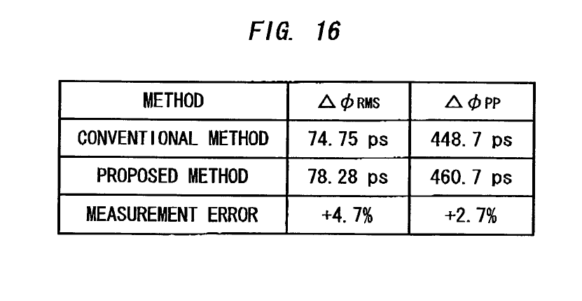

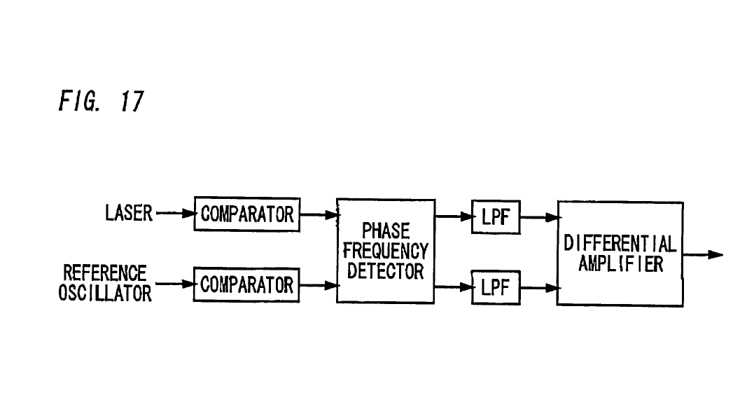

FIG. 16 shows an example of comparison result of timing jitter values measured by a conventional jitter measurement method (Δφ method) and the jitter measurement method according to the present embodiment. FIG. 16 shows the result of the comparison of RMS value (ΔφRMS) and peak-to-peak value (ΔφPP) measured by the jitter measurement method according to the present embodiment with those measured by the Δφ method. As shown in FIG. 16, according to the jitter measurement method of the present embodiment, it is possible to obtain the timing jitter values that are compatible with the conventional method.

As described above, according to the jitter measurement method 200 of the present embodiment, a timing jitter measurement apparatus and a jitter measurement method can be provided which enable the measurement of the timing jitters that are compatible with a conventional time-interval analyzer method, Δφ method and spectrum analyzer method.

Although the present invention has been described by way of exemplary embodiments, it should be understood that those skilled in the art might make many changes and substitutions without departing from the spirit and the scope of the present invention which is defined only by the appended claims.

For example, the jitter measurement apparatus 200 according to the present embodiment can be applied to jitter estimation of a signal other than the clock signal, such as a data signal, as the signal under measurement. In other words, by inputting a test pattern for causing the DUT 20 to output a signal similar to the clock signal, that has a constant reference period, to the DUT 20, for example, it is possible to cause the DUT 20 to output the signal similar to the clock signal.

As is apparent from the above, according to the present invention, the jitter measurement apparatus and jitter measurement method can be provided which enables the simple and precise measurement for the signal under measurement.

What is claimed is:

1. A jitter measurement apparatus for measuring a jitter of a signal under measurement, comprising:
a delay circuit operable to generate a delayed signal that is delayed from said signal under measurement by a predetermined delay time; and
a phase detector operable to detect an instantaneous phase error between said signal under measurement and said delayed signal.

2. A jitter measurement apparatus as claimed in claim 1, further comprising an accumulator operable to accumulate said instantaneous phase error and to output a timing jitter sequence of said signal under measurement based on a value of accumulation.

3. A jitter measurement apparatus as claimed in claim 2, further comprising a linear component remover operable to output non-linear components of said timing jitter sequence by removing a linear component of said timing jitter sequence.

4. A jitter measurement apparatus as claimed in claim 3, wherein said linear component remover outputs said non-linear components of said timing jitter sequence by removing a DC component of said timing jitter sequence.

5. A jitter measurement apparatus as claimed in claim 2, wherein said accumulator includes a converter operable to convert said instantaneous phase error to an electric signal and an integrator operable to integrate and accumulate said electric signal, and wherein a discharge circuit is further provided operable to remove a linear component included in said instantaneous phase error, accumulated in said integrator to correspond to said delay time, from said integrator.

6. A jitter measurement apparatus as claimed in claim 2, further comprising a jitter detector operable to detect said jitter of said signal under measurement based on said timing jitter sequence.

7. A jitter measurement apparatus as claimed in claim 6, wherein said jitter detector includes a peak-to-peak detector operable to calculate said jitter based on a difference between a maximum value and a minimum value of said timing jitter sequence.

8. A jitter measurement apparatus as claimed in claim 6, wherein said jitter detector includes a root mean square (RMS) detector operable to calculate said jitter based on a root mean square value of said timing jitter sequence.

9. A jitter measurement apparatus as claimed in claim 6, wherein said jitter detector includes a histogram estimator operable to calculate a histogram of said timing jitter sequence.

10. A jitter measurement apparatus as claimed in claim 1, further comprising a period jitter estimator operable to calculate a period jitter of said signal measurement based on said instantaneous phase error.

11. A jitter measurement apparatus as claimed in claim 10, wherein said period jitter estimator calculates said period jitter sequence by subtracting a mean value of said instantaneous phase error from said instantaneous phase error.

12. A jitter measurement apparatus as claimed in claim 1, wherein said delay circuit generates said delayed signal by delaying said signal under measurement by N periods (where N is an integer equal to or larger than one), and
said phase detector calculates a period jitter sequence of said signal under measurement by detecting said instantaneous phase error between said signal under measurement and said delayed signal delayed from said signal under measurement by N periods.

13. A jitter measurement apparatus as claimed in claim 10 or 12, further comprising a differentiator operable to calculate a differential sequence of said period jitter sequence and outputs said differential sequence as a cycle-to-cycle period jitter sequence of said signal under measurement.

14. A jitter measurement apparatus as claimed in claim 1, wherein said delay circuit is a digitally-controlled variable delay circuit operable to hold said delay time in a variable manner.

15. A jitter measurement apparatus as claimed in claim 1, further comprising an accumulator operable to accumulate said period jitter sequence and output a timing jitter sequence of said signal under measurement based on the accumulated value.

16. A jitter measurement apparatus as claimed in claim 15, wherein said accumulator includes:
a converter operable to convert said period jitter sequence into an electric signal; and
an integrator operable to integrate and accumulate said electric signal.

17. A jitter measurement method for measuring a jitter of a signal under measurement, comprising:
generating a delayed signal that is delayed from said signal under measurement by a predetermined delay time; and
detecting an instantaneous phase error between said signal under measurement and said delayed signal.
